(19) United States
(12) Patent Application Publication
(10) Pub. No.: US 2013/0155037 A1
(43) Pub. Date: Jun. 20, 2013

(54) ORGANIC LIGHT EMITTING DISPLAY DEVICE HAVING TEST PAD

(71) Applicants: Na-Young Kim, Yongin-si (KR); Keum-Nam Kim, Yongin-si (KR)

(72) Inventors: Na-Young Kim, Yongin-si (KR); Keum-Nam Kim, Yongin-si (KR)

(21) Appl. No.: 13/619,801

(22) Filed: Sep. 14, 2012

(30) Foreign Application Priority Data
Dec. 20, 2011 (KR) 10-2011-0137879

(51) Int. Cl. G09G 3/32; G06F 3/038

(52) U.S. Cl. 345/204; 345/82

(57) ABSTRACT

Disclosed is a light emitting display device which includes test pads for respective pixels to efficiently inspect an open or short of a circuit, that is, a short-circuiting or a breaking of wire.

### CROSS-REFERENCE TO RELATED APPLICATION

This application claims priority to and the benefit of Korean Patent Application No. 10-2011-0137879 filed in the Korean Intellectual Property Office on Dec. 20, 2011, the entire contents of which are incorporated herein by reference.

### BACKGROUND

1. Field

Embodiments of the present invention relate to an organic light emitting display device having test pads.

2. Description of the Related Art

In recent years, organic light emitting display devices are being spotlighted in the field of display technology. The organic light emitting display device is a type of display device adapted to emit light which is generated when electrons and holes are coupled or recombined together to form excitons and then decay.

The organic light emitting display device generally includes an electrode for injecting holes, an electrode for injecting electrons, and a light emitting layer. The organic light emitting display has a structure where the light emitting layer is stacked between an anode, i.e. the electrode for injecting the holes, and a cathode, i.e. the electrode for injecting the electrons.

FIG. 1 is a drawing illustrating a driving principle of an organic light emitting display device.

As shown in FIG. 1, the organic light emitting display device has multiple layers including an electron emitting layer (EML), an electron transport layer (ETL), and a hole transport layer (HTL), and may further include a separate electron injecting layer (EIL) and a separate hole injecting layer (HIL).

In more detail, electrons are injected at a cathode of the organic light emitting display device, and holes are injected at an anode. The electrons and holes move in opposite directions by an external electric field, and are coupled or recombined together in the light emitting layer to form excitons and then decay while emitting light. In such an organic light emitting display device, the light emitting layer may be formed of a monomer or polymer organic material.

Since the organic light emitting display device uses a self light emitting device, it has excellent viewing angle and contrast. Further, since it does not use a backlight, it can be made light and thin and may have reduced power consumption. In addition, the organic light emitting device is driven by a relatively low DC voltage, has a quick response, is strong against an external impact since all the elements are solid, has a wide in-use temperature range, and is manufactured though a simple method and with low costs.

Such an organic light emitting display device is generally manufactured by forming a TFT array including a plurality of thin film transistors and capacitors on a substrate through a semiconductor fabrication process, and stacking one or more organic film layers including at least a light emitting layer on a display unit of the substrate on which the TFT array is formed.

Test pads may be arranged in the organic light emitting display device to inspect a defect during or after the manufacturing process.

In more detail, as illustrated in FIG. 2, the organic light emitting display device generally includes a display unit 20 which is a light emitting region formed on an insulation substrate 10 made of a plastic or glass, scan driving units 30 and 40 for driving thin film transistors coupled to respective pixels of the display unit 20, a second electrode 60 which is a common electrode covering substantially the whole surface of the substrate 10, and test pads 50 for testing whether the thin film transistors of the display unit 20 normally operate or not. In FIG. 2, the test pads 50 are disposed outside of the display unit 20 in which a plurality of pixels are aligned.

In, FIG. 2, the test pads 50 use a scanning signal generated by the scan driving unit 30.

In such an organic light emitting display device, a signal is supplied from one side of the driving unit to the test pads and is detected at the other side, so that it can be determined whether or not the circuit operates normally by comparing a waveform of the detected signal with a waveform of the supplied signal. In particular, the test method is useful to determine whether the circuit is short or open, and this test is inevitably necessary for the mass production of large-sized panels.

However, in recent years, in a large organic light emitting display device, pixels are arranged differently as compared with the prior organic light emitting display device. Thus, if the test pads are arranged only at signal lines (e.g., scanning lines) extracted from a driving unit (e.g., scan driving unit) as in the prior art, all components of a display device may not be tested properly. Consequently, there is a need of varying a disposition of test pads when a disposition of pixels of an organic light emitting display device is varied.

### SUMMARY

Accordingly, embodiments of the present invention have been made to solve the above-mentioned problems occurring in the prior art, and an embodiment of the present invention provides an organic light emitting display device having test pads which can identify an existence and a location of a defect of an element by applying one inspection.

An embodiment of the present invention also provides a method of manufacturing an organic light emitting display device.

In accordance with one embodiment of the present invention, there is provided an organic light emitting display device including: a substrate; a display unit on the substrate and including a plurality of pixels; a driver for providing a drive signal to the display unit; a plurality of signal lines for transferring the drive signal to the display unit; and a plurality of test pads electrically coupled to the signal lines, wherein the signal lines extend from the driver and branch out to a plurality of branch lines, which are respectively coupled to the pixels of the display unit, and wherein the test pads are electrically coupled to the branch lines respectively.

According to an embodiment of the present invention, the display unit may include a first electrode, a light emitting layer on the first electrode, and a second electrode on the light emitting layer.

According to an embodiment of the present invention, the driver may include at least one of a scan driver or a data driver.

According to an embodiment of the present invention, the driver may include a scan driver, and the signal lines may include scan lines.

According to an embodiment of the present invention, the pixels may include a red pixel, a green pixel, and a blue pixel.

According to an embodiment of the present invention, the branch lines may be coupled to the red pixel, the green pixel, and the blue pixel, respectively.

According to an embodiment of the present invention, the test pads may be coupled to the branch lines respectively.

According to an embodiment of the present invention, the test pads may be configured to inspect an open or short of a circuit. That is, the test pads may be used to inspect a breaking of a wire, i.e. open-circuiting, or a short-circuiting. The test pads may include an O/S test pad.

According to an embodiment of the present invention, the signal lines and the branch lines may be formed of different materials.

According to an embodiment of the present invention, an option pad may be coupled to the signal line.

According to an embodiment of the present invention, the organic light emitting display device may further include an option pad coupled in parallel to the test pads.

In accordance with another embodiment of the present invention, there is provided a method of manufacturing an organic light emitting display device, the method including: forming a display unit including a plurality of pixels on a substrate; forming a driver spaced apart from the display unit; forming signal lines coupling the display unit to the driver; and forming test pads electrically coupled to the signal line, wherein the forming of the signal lines includes forming a plurality of branch lines branched out from one signal line extended from the driver such that the plurality of branch lines are respectively coupled to pixels of the display unit, and the forming of the test pads or the forming of the branch lines include coupling the test pads to the branch lines respectively.

According to an embodiment of the present invention, the forming of the display unit may include forming a first electrode, forming a light emitting layer on the first electrode, and forming a second electrode on the light emitting layer.

According to an embodiment of the present invention, the forming of the driver may include at least one of forming a scan driver or forming a data driver. The driver may include a scan driver, and the signal lines may include scan lines.

According to an embodiment of the present invention, the forming of the display unit may include forming a red pixel, forming a green pixel, and forming a blue pixel. The red pixel, the green pixel, and the blue pixel may be coupled to the branch lines respectively.

According to an embodiment of the present invention, the test pads may be coupled to the branch lines respectively.

According to an embodiment of the present invention, the signal lines and the branch lines may be formed of different materials.

According to an embodiment of the present invention, the method may further include forming an option pad coupled to the signal lines. The method may further include coupling the option pad in parallel to the test pads.

In accordance with another embodiment of the present invention, there is provided an organic light emitting display device including: a substrate; a display unit formed on the substrate and including a red pixel, a green pixel, and a blue pixel; a scan driver for providing a scan signal to the display unit; a plurality of scan lines for transferring the scan signal generated by the scan driver to the display unit; branch lines branched from the scan line and respectively coupled to the red pixel, the green pixel, and the blue pixel; and test pads electrically coupled to the branch lines respectively.

The organic light emitting display device according to the embodiments of the present invention can efficiently inspect a breaking of a wire (open-circuiting) or a short-circuiting with the test pads provided to the respective pixels. In particular, according to the embodiments of the present invention, even though an organic light emitting display device has a structure that one scanning line provides a plurality of scanning signals, since the test pads are provided to the respective pixels, a short-circuiting or a breaking of a wire (open-circuiting) can be efficiently inspected.

### BRIEF DESCRIPTION OF THE DRAWINGS

The above and other objects, features and aspects of the present invention will be more apparent from the following detailed description taken in conjunction with the accompanying drawings, in which:

FIG. 1 is a view illustrating a driving principle of an organic light emitting display device;

FIG. 2 is a view illustrating a structure of a conventional organic light emitting display device;

FIG. 3 is a view illustrating a relation among a drive unit, a display unit, and signal lines extending from the drive unit of an organic light emitting display device;

FIG. 4 is a view illustrating an example of a connection structure of signal lines extending from a pixel drive unit and pixels in an organic light emitting display device;

FIG. 5 is a comparison example of the present invention according to an embodiment, and illustrates that a test pad is disposed in the organic light emitting display device of FIG. 4;

FIG. 6 is a view diagrammatically illustrating an example of a state where test pads are disposed in the organic light emitting display device according to an embodiment of the present invention;

FIG. 7 is a view diagrammatically illustrating an example of a state where test pads and an option pad are disposed in the organic light emitting display device according to another embodiment of the present invention;

FIG. 8 is a view diagrammatically illustrating another example of a state where test pads and an option pad are disposed in the organic light emitting display device according to another embodiment of the present invention.

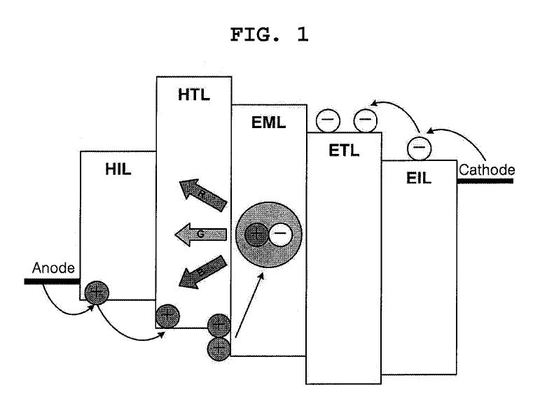

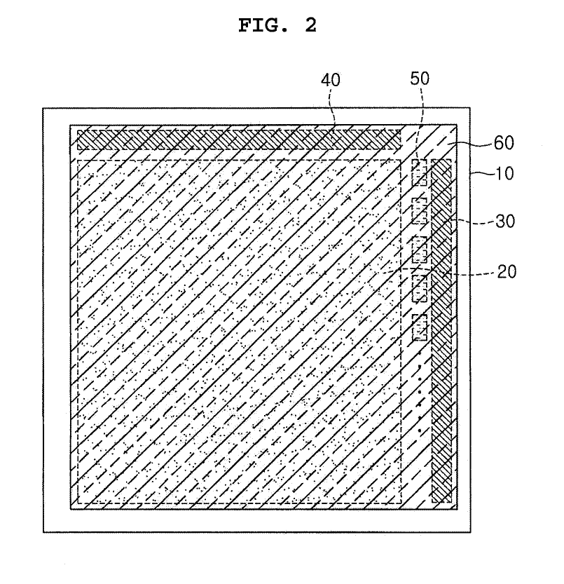

### DETAILED DESCRIPTION OF THE EMBODIMENTS

Hereinafter, an exemplary embodiment of the present invention will be described in more detail with reference to the accompanying drawings. However, the scope of the present invention is not limited to the below-described embodiments and the accompanying drawings.

For reference, the elements and their shapes are simply drawn or exaggerated in the drawings to help understanding of the present invention. In the drawings, the same reference numerals denote the same elements.

Further, when it is described that a layer or element is located on another layer or element, the layer or element may directly contact the other layer or element, or a third layer or element may be interposed therebetween.

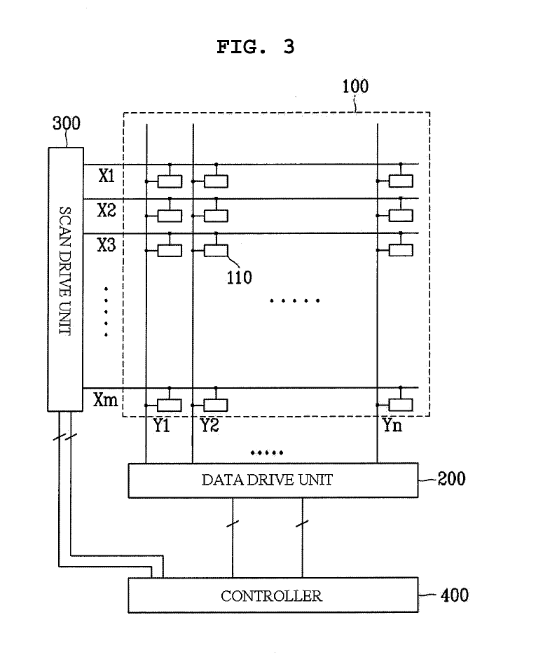

FIG. 3 illustrates a basic structure of an organic light emitting display device.

As mentioned above, the organic light emitting display device according to an embodiment of the present invention includes a substrate, a display unit 100 formed on the substrate and having a plurality of pixels 110, drive units (e.g., 200 and 300) for providing drive signals to the display unit 100, and a plurality of signal lines X1 to Xm and Y1 to Yn for transferring the drive signals generated by the drive units 200 and 300 to the display unit 100.

Although not illustrated in FIG. 3, a substrate generally used in an organic light emitting display device may be arbitrarily selected as the substrate of the organic light emitting display device of FIG. 3. An example of the substrate may include a glass substrate or a transparent plastic substrate having a suitable mechanical strength, a thermal stability, a transparency, and a flat surface, which can be easily treated and water-proofed. The substrate may further include a planarization layer or an insulation layer as occasion demands.

The display unit 100 is formed on the substrate. The display unit 100 is at a region corresponding to the light emitting unit of the organic light emitting display device, which includes a first electrode, a light emitting layer formed on the first electrode, and a second electrode formed on the light emitting layer.

The display unit 100 includes a plurality of data lines Y1 to Yn arranged in columns (or rows), a plurality of scan lines X1 to Xm arranged in rows (or columns), and a plurality of pixel circuits 110.

The data lines and scan lines correspond to signal lines. Each of data lines Y1 to Yn transfers a data voltage corresponding to an image to a pixel circuit 110, each of scan lines X1 to Xm transfers a selection signal to the pixel circuit 110. One pixel circuit 110 is formed in a pixel region defined by two adjacent data lines and two adjacent scan lines. In the organic light emitting display device according to the present embodiment, the pixels (e.g., the pixel circuit 110) formed in the pixel region are red pixels, green pixels, and blue pixels.

The organic light emitting display device illustrated in FIG. 3 includes a scan drive unit 300 and a data drive unit 200 as the drive units.

The scan drive unit 300 sequentially applies selection signals to the scan lines X1 to Xm, and the data drive unit 200 concurrently (e.g., simultaneously) applies data voltages to the data lines Y1 to Yn. The controller 400 provides data signals applied by the drive units 200 and 300 and a plurality of control signals for displaying an image according to the data signals.

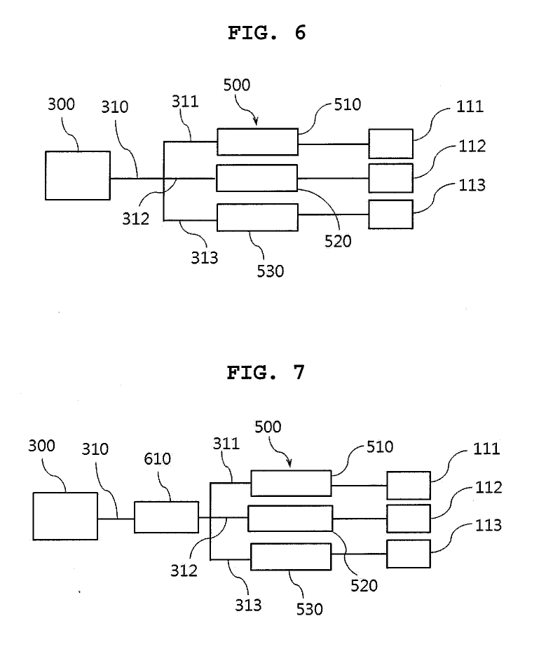

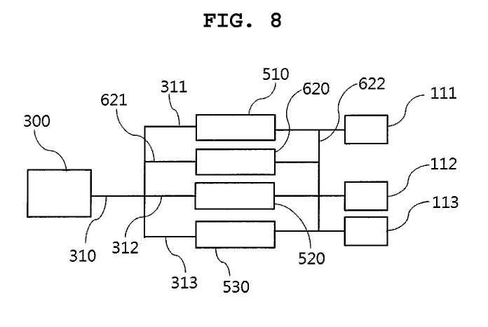

The organic light emitting display device according to the present invention includes test pads 500 (see FIGS. 6 and 7) for inspecting an operational state of the organic light emitting display device. Here, the test pads 500 are electrically coupled to the signal lines. The signal lines include data lines coupled to the data drive unit (e.g., data drive unit 200 or data driver) and scan lines coupled to the scan drive unit (e.g., scan drive unit 300 or scan driver).

Hereinafter, a case where the test pads are coupled to scan lines will be described as an example. Of course, the test pads may be coupled to data lines.

Referring to FIG. 3, the controller 400 may provide inspection control signals and an inspection voltage to the test pads for inspecting an operational state of the display unit 100. When one of the test pads is not operated, the data voltage from the data drive unit 200 may be supplied to the data lines of the display unit 100.

As large-sized organic light emitting display devices are recently being developed, a pixel rotation structure (PRS) is often employed to improve an arrangement of pixels and enhance light emitting efficiency.

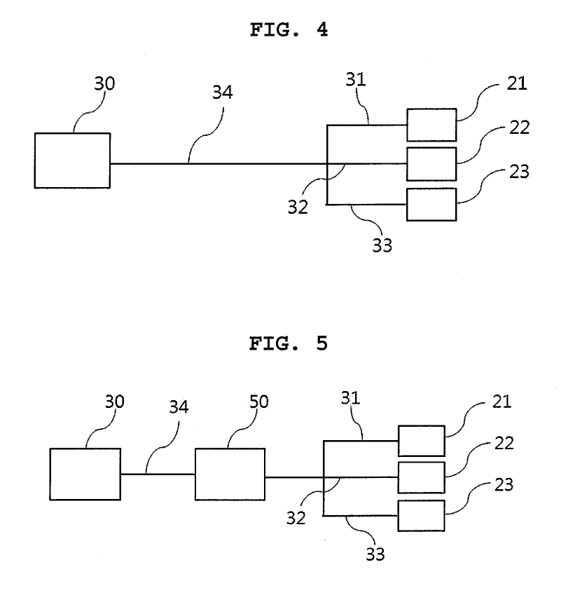

In this regard, FIG. 4 illustrates an example of a disposition of pixels in the PRS structure. In the illustrated PRS structure, one scan line is not directly coupled to the pixels, but three pixels including a red pixel 21, a green pixel 22, and a blue pixel 23 create a group such that one scan line 34 is allocated to the group, and branch lines 31, 32, and 33 branched out from the scan line 34 are applied to the respective pixels.

In the organic light emitting display device having such an arrangement, as in the conventional technology, if one test pad 50 is disposed on the scan line 34 (see FIG. 5), and an inspection is carried out, a defect may be detected after the inspection, but it cannot be identified on which of the three branch lines 31, 32, and 33 the defect occurred.

FIG. 5 illustrates an example of disposing one test pad 50 with respect to one scan line 34. When test pads are disposed in the above structure, even if a defect is detected after the test, it cannot be identified on which of the three branch lines 31, 32, and 33 a defect occurred, and thus a separate test should be carried out to identify an accurate defect location.

In addition, the defected portion should be repaired or serviced. However, if multiple tests are needed to find the accurate defect location, a lot of time is consumed in the repairing or servicing process. Further, in order to identify whether a defect is properly repaired or serviced, several inspections should be carried out likewise.

In order to solve this problem, in an embodiment of the present invention, the signal line extended from the drive unit is branched out to a plurality of branch lines. When the plurality of branch lines are coupled to the respective pixels of the display unit, the test pads 500 are electrically coupled to the branch lines, respectively.

In more detail, as illustrated in FIG. 6, the signal line 310, which extends from the scan drive unit 300, is branched out to a plurality of branch lines 311, 312, and 313 to be coupled to the respective pixels 111, 112, and 113, and the test pads 510, 520, and 530 are disposed on the respective branch lines 311, 312, and 313. That is, the branch lines 311, 312, and 313 branched out from the scan line 310 are coupled to the red pixel 111, the green pixel 112, and the blue pixel 113, respectively; and the test pads 510, 520, and 530 are coupled to the branch lines coupled to the red pixel 111, the green pixel 112, and the blue pixel 113, respectively.

The test pads 510, 520, and 530 are pads for inspecting a defect of an organic light emitting display device. An example of such a test pad includes a test pad for inspecting an open or short of a circuit, that is, for inspecting a breaking of a wire and a short-circuiting. Such a test pad is also called O/S test pad, and the O/S test pad currently applied in the art to which the present invention pertains may be used.

The signal lines, i.e. the scan line 310 and the branch lines 311, 312, and 313, may be formed of a same material or may be formed of different materials. In order to easily discern signal waveforms for inspection, the scan line and the branch lines may be formed of different materials.

FIG. 7 illustrates another embodiment of the present invention. In FIG. 7, an option pad 610 is coupled to the signal line, i.e. the scan line 310. When the option pad 610 is used, a defect generated between the scan line 310 and the branch lines 311, 312, and 313 may be inspected. An O/S test pad currently applied in the art to which the present invention pertains may be used as the option pad 60.

Since when a breaking of a wire (open-circuiting) or a short-circuiting is inspected by using the O/S test pad, the inspection is carried out with a very fine needle called a scalp needle, and the size of the option pad can be small. Thus, if only a very small space is secured, the option pad may be disposed. When the scan line 310 and the branch lines 311, 312, and 313 are formed of different materials, the option pad 610 may be formed on the test pads 510, 520, and 530.

FIG. 8 illustrates another embodiment of the present invention. In FIG. 8, the option pad is coupled in parallel to the test pads.

In FIG. 8, in order to connect the option pad 620 to the signal line, i.e. the scan line 310, a separate branch line 621 is formed to connect the option pad 620 to the scan line 310, and a separate bridge wire 622 is formed for the branch lines introduced into the pixels to bridge the branch lines introduced into the pixels. Accordingly, when the option pad 620 is used, a defect between the test pads 510, 520, and 530 and the pixels 111, 112, and 113 can be inspected.

When the branch line 621 coupled to the option pad 620, and the bridge wire 622, are formed of a material different from that of the branch lines 311, 312, and 313, the option pad 620 may be formed to contact the test pads 510, 520, and 530 or may be formed on the test pads.

In the case where test pads are disposed in the structure disclosed in the embodiments of the present invention, when a defect is generated after or during a test, the location of the defect can be easily identified. Further, it can be identified whether the defect is properly repaired only with one test after the repair.

The present invention also provides a method of manufacturing the organic light emitting display device.

The method of manufacturing the organic light emitting display device includes the steps of forming a display unit 100 including a plurality of pixels on a substrate, forming a drive unit 200 and 300 such that the drive units 200 and 300 are spaced apart from the display unit 100, forming signal lines X1 to Xm and Y1 to Yn for connecting the display unit to the drive units 200 and 300, and forming test pads 500 such that the test pads 500 are electrically coupled to the signal lines X1 to Xm and Y1 to Yn.

The step of forming the signal lines includes the step of forming a plurality of branch lines 311, 312, and 313 branched out from one signal line 310 extended from the drive unit such that the plurality of branch lines 311, 312, and 313 are coupled to pixels 111, 112, and 113 of the display unit 100, and the step of forming the test pads 500 or the step of forming the branch lines 311, 312, and 313 includes the step of connecting the test pads 500 to the branch lines 311, 312, and 313.

The step of forming the display unit 100 includes the steps of forming a first electrode, forming a light emitting layer on the first electrode, and forming a second electrode on the light emitting layer. The step of forming the display unit 100 includes the step of forming a red pixel 111, forming a green pixel 112, and forming a blue pixel 113. In the step of forming the display unit 100, any method of forming the pixel that is conventionally applied in the manufacture of an organic light emitting display device can be used.

The step of forming the drive unit may include at least one of the step of forming a scan drive unit 300 and the step of forming a data drive unit 200. Hereinafter the embodiment will be described with the assumption that the scan drive unit 300 is formed as the drive unit and a scan line 310 extended from the scan drive unit 300 is formed as the signal line.

Branch lines 311, 312, and 313 are coupled to a red pixel 111, a green pixel 112, and a blue pixel 113, respectively. The test pads 510, 520, and 530 are coupled to the branch lines 311, 312, and 313 that are coupled to the red pixel 111, the green pixel 112, and the blue pixel 113, respectively. Then, an O/S test pad for inspecting an open or short of a circuit may be coupled to the test pads 510, 520, and 530.

The signal line, i.e. the scan line 310, and the branch line may be formed of different materials.

Here, a method of manufacturing the organic light emitting display device according to another example may further include the step of connecting an option pad 610 to a signal line, i.e. a scan line 310. The option pad 610 may be coupled to the test pads 510, 520, and 530 in parallel.

An embodiment of the present invention provides an organic light emitting display device including: a substrate; a display unit (e.g., 100) formed on the substrate and including a red pixel (e.g., 111), a green pixel (e.g., 112), and a blue pixel (e.g., 113); a scan drive unit (e.g., 300) for providing a scan signal to the display unit; a plurality of scan lines (e.g., 310) for transferring the scan signal generated by the scan drive unit to the display unit; branch lines (e.g., 311, 312, and 313) branched from the scan line and coupled to the red pixel, the green pixel, and the blue pixel; and test pads (e.g., 510, 520, and 530) electrically coupled to the branch lines.

What is claimed is:

1. An organic light emitting display device comprising:
a substrate;
a display unit on the substrate and comprising a plurality of pixels;
a driver for providing a drive signal to the display unit;
a plurality of signal lines for transferring the drive signal to the display unit; and
a plurality of test pads electrically coupled to the signal lines,
wherein the signal lines extend from the driver and branch out to a plurality of branch lines, which are respectively coupled to the pixels of the display unit, and
wherein the test pads are electrically coupled to the branch lines respectively.

2. The organic light emitting display device as claimed in claim 1, wherein the display unit comprises a first electrode, a light emitting layer on the first electrode, and a second electrode on the light emitting layer.

3. The organic light emitting display device as claimed in claim 1, wherein the driver comprises at least one of a scan driver or a data driver.

4. The organic light emitting display device as claimed in claim 1, wherein the driver comprises a scan driver, and the signal lines comprise scan lines.

5. The organic light emitting display device as claimed in claim 1, wherein the pixels include a red pixel, a green pixel, and a blue pixel.

6. The organic light emitting display device as claimed in claim 5, wherein the branch lines are coupled to the red pixel, the green pixel, and the blue pixel, respectively, and the test pads are coupled to the branch lines respectively.

7. The organic light emitting display device as claimed in claim 1, wherein the test pads are configured to inspect an open or short of a circuit.

8. The organic light emitting display device as claimed in claim 1, wherein the signal lines and the branch lines comprise different materials.

9. The organic light emitting display device as claimed in claim 1, further comprising an option pad coupled to the signal lines.

10. The organic light emitting display device as claimed in claim 1, further comprising an option pad coupled in parallel to the test pads.

11. A method of manufacturing an organic light emitting display device, the method comprising:
forming a display unit comprising a plurality of pixels on a substrate;
forming a driver spaced apart from the display unit;
forming signal lines coupling the display unit to the driver; and
forming test pads electrically coupled to the signal lines,
wherein the forming of the signal lines comprises forming a plurality of branch lines branched out from one signal line extended from the driver such that the plurality of branch lines are respectively coupled to pixels of the display unit, and the forming of the test pads or the forming of the branch lines comprises respectively coupling the test pads to the branch lines.

12. The method as claimed in claim 11, wherein the forming of the display unit comprises forming a first electrode, forming a light emitting layer on the first electrode, and forming a second electrode on the light emitting layer.

13. The method as claimed in claim 11, wherein the forming of the driver comprises at least one of forming a scan driver or forming a data driver.

14. The method as claimed in claim 11, wherein the driver comprises a scan driver, and the signal lines comprise scan lines.

15. The method as claimed in claim 11, wherein the forming of the display unit comprises forming a red pixel, forming a green pixel, and forming a blue pixel.

16. The method as claimed in claim 15, wherein the red pixel, the green pixel, and the blue pixel are coupled to the branch lines, respectively, and the test pads are coupled to the branch lines, respectively.

17. The method as claimed in claim 11, wherein the test pads are configured to inspect an open or short of a circuit.

18. The method as claimed in claim 11, wherein the signal lines and the branch lines are formed of different materials.

19. The method as claimed in claim 11, further comprising forming an option pad coupled to the signal lines.

20. The method as claimed in claim 11, further comprising forming an option pad coupled in parallel to the test pads.

21. An organic light emitting display device comprising:
a substrate;
a display unit on the substrate and comprising a red pixel, a green pixel, and a blue pixel;
a scan driver for providing a scan signal to the display unit;
a plurality of scan lines for transferring the scan signal to the display unit;
branch lines branched from a scan line of the plurality of scan lines, and coupled to the red pixel, the green pixel, and the blue pixel, respectively; and
test pads electrically coupled to the branch lines.
